(19) United States
(12) Patent Application Publication
(10) Pub. No.: US 2019/0032630 A1
(43) Pub. Date: Jan. 31, 2019

(54) WIND TURBINE AND METHOD FOR GENERATING ELECTRICAL ENERGY

(71) Applicant: Alex Keller, Rastatt (DE)

(72) Inventor: Alex Keller, Rastatt (DE)

(21) Appl. No.: 16/111,257

(22) Filed: Aug. 24, 2018

Related U.S. Application Data
(63) Continuation of application No. PCT/DE2017/000047, filed on Feb. 24, 2017.

(30) Foreign Application Priority Data
Feb. 26, 2016 (DE) 102016002226.4

(51) Int. Cl. F03D 1/04; F03D 1/02; F03D 1/06; F03D 9/25

(52) U.S. Cl. CPC F03D 1/04; F03D 1/02; F03D 1/0625; F03D 9/25; F03D 1/0666; F03D 1/0675; F03D 1/0633

(57) ABSTRACT

A wind turbine having a high sensitivity to wind speeds, which makes it suitable for generating energy at very low wind speeds. The wind turbine is also smaller in size and lighter in weight, so that multiple wind turbines according to the invention may be mounted on a single mast, thereby reducing the total area required to generate a desired amount of energy. The various components of the wind turbine are designed to compress, accelerate, and control the direction of flow of the air stream through the turbine, so as to optimize the energy that is obtained from the inflowing air stream.

### BACKGROUND INFORMATION

### Field of the Invention

The present invention relates to a wind turbine and to a method for generating electrical energy from an air stream by means of said wind turbine.

### Discussion of Prior Art

Wind energy technology is developing at a high rate owing to the great wind resources on our planet. These resources are great enough for electricity to be generated in a virtually unlimited and substantially ecological manner, which electricity can to a major extent replace traditional fossil fuels and nuclear energy. It is consequently necessary to develop highly efficient wind power installations which, utilizing the available wind potential, can generate large amounts of electricity with low primary investment costs and offer attractive prices for the end consumer.

Generic wind power installations and methods are known per se from the prior art. Wind power installations are at present designed with rotors with a large diameter of up to 164 meters, for example in the case of the Vestas V164-8.0 type, wherein installations with high energy density at present provide up to 10 MW. The tendencies in development up to the year 2020 are directed to creating offshore wind power installations, which are intended to have a maximum power of approximately 20 MW and which will have a rotor diameter of up to 300 meters.

To generate a large amount electrical energy, conventional wind power installations are reliant on a very wide air stream through rotors with a large diameter. These large rotors are however heavy and bulky and difficult to install, maintain, and repair. The circumferential speed at the ends of the rotor blades reaches a very high level, even in the case of a low working frequency of the installation of 7 rpm to 13 rpm. The resistance moments owing to high friction and also wear on the parts resulting from the friction are very great. Accordingly, the structures are very large, heavy, and expensive. As a result of vortex formation involving large air masses that pass through the wind power installations, the individual wind power installations influence one another at short distances, in particular if they stand close together in so-called wind farms. Consequently, a significant spacing of the wind power installations within a wind farm is necessary. Furthermore, wind power installations are put at extreme risk in the presence of supercritical wind speeds, such that they are not operated in the presence of high wind speeds. Said wind power installations therefore pose a major hazard to people and animals, in particular birds. This fact is a common reason for the impulsive reactions of environmentalists and the affected population in general.

Current developments are directed to achieving high effectiveness through suitable transformation of local air streams, by means of which relatively large amounts of energy are generated through the concentration of relatively small air masses. Here, it is possible for two principles to be used and combined, specifically concentration and acceleration of local air streams, in order to generate a high dynamic pressure, and generating a turbulent air stream, in order to generate a difference in the static pressure.

US 2004/0183310 A1 describes a simple wind energy generator which has a funnel-shaped housing with a large inlet and which has a concave inner surface which tapers toward an outlet, in which there is arranged an electrical generator operated by means of a propeller. The wind energy generator is based on the Bernoulli principle that wind entering the funnel-shaped housing is accelerated and is directed at high speed toward the propeller.

According to the prior art, it is economically not expedient to operate wind power installations in the presence of wind speeds below 8 m/s, because the energy creation lies below 80%. On the other hand, conventional wind power installations can only be safely operated up to wind speeds of 25 m/s.

To generate electrical power of, for example, 175 MW, using conventional wind power installations according to the prior art, use must be made of approximately 87 individual installations, that is to say 87 masts, over an area of approximately 870,000 square meters. The investment required for the wind power installations alone is approximately € 170 million, without allowing for land plot prices and infrastructure.

There is therefore an urgent need for wind power installations which are more compact, involve lower costs, and are more efficient. For this purpose, it will be necessary to install greater capacities than before on an individual mast, and to seek ways of positioning these individual masts closer together in a wind farm than is presently the case. Only in this way is it possible to save costs for land plots and infrastructure. An aspect for future wind power installations that cannot be underestimated is the safety thereof with regard to people and animals, in particular birds, and good environmental compatibility in general.

### BRIEF SUMMARY OF THE INVENTION

Taking the above-stated disadvantages of the prior art as a starting point, it is the object of the present invention to provide a wind power installation which can generate a significant amount of electricity with an air stream of relatively low capacity. A further aim of the invention is to improve the efficiency and effectiveness of wind power installations.

The object is achieved in a first aspect of the present invention by means of a wind turbine (1) comprising
an inner corpus that has a cylindrical main body with a cowling attached upstream and has a generator arranged in the cylindrical main body,
an outer corpus that has a housing casing and at least one funnel component arranged in the housing casing, the cross section of which funnel component decreases in a flow direction, and a spherical cap component arranged downstream in the housing casing,
at least one carrier rib that connects the inner corpus to the outer corpus, and
a working turbine that is arranged at the downstream end of the inner corpus and that is connected to the generator and which has a rotor,

wherein the outer corpus forms, with the inner corpus, at least one convergent portion which extends over the length of the inner corpus, and wherein the outer corpus, adjoining the downstream end of the inner corpus, forms a divergent portion.

The object is furthermore achieved in a second aspect of the present invention by means of a method for generating electrical energy from an air stream by means of the wind turbine according to the invention, which method comprises the steps:

a) receiving an air stream from the surroundings in the at least one convergent portion of the wind turbine,

b) accelerating and compressing the air stream in the at least one convergent portion by means of a progressive decrease of the cross-sectional area thereof,

c) conducting the accelerated, compressed air stream in targeted fashion to the rotor, and thereby driving the working turbine,

d) after it passes through the rotor, introducing the accelerated, compressed air stream into the divergent portion and slowing and expanding the air stream.

The invention has the advantages that, firstly, the efficiency of the individual wind turbines is increased in relation to conventional wind power installations, because there is basically no limitation with regard to the utilizable wind speed. Furthermore, the area requirement of the individual wind turbines is smaller, whereby the wind utilization per unit of area is greatly increased. Furthermore, multiple wind turbines can be arranged on a conventional mast. To generate the abovementioned electrical power of for example 175 MW, with the present invention, one requires only 13 masts (rather than 87) with in each case seven wind turbines according to the invention, and an area of only approximately 22,500 square meters (rather than 870,000 square meters).

### BRIEF DESCRIPTION OF THE DRAWINGS

The invention is described in detail below with reference to the following schematic illustrations.

FIG. 1 is a schematic, partially sectional illustration of a wind turbine 1 according to the invention as per an embodiment of the invention.

FIG. 2 is a schematic, partially sectional illustration of an inner corpus 3 as per an embodiment of the invention.

FIG. 3a is a schematic sectional illustration of an outer corpus 5 as per an embodiment of the invention with convergent portion 507 and divergent portion 509.

FIG. 3b shows a diagram for illustrating dynamic pressure and static pressure.

FIG. 4 is a schematic sectional illustration of a wind turbine 1 according to the invention as per an embodiment of the invention.

FIG. 5 is a schematic illustration of a wind turbine 1 according to the invention as per an embodiment of the invention.

FIG. 6 is a schematic, partially sectional detail illustration of a wind turbine 1 according to the invention as per an embodiment of the invention.

FIG. 7 is a schematic illustration of a working turbine 9 as per an embodiment of the invention.

FIG. 8 shows a front view of a wind turbine 1 according to the invention as per an embodiment of the invention.

FIG. 9a is a side plan view showing multiple wind turbines 1 mounted on one mast 13.

FIG. 9b is front plan view of the multiple wind turbines 1 shown in FIG. 9a.

### DETAILED DESCRIPTION OF THE INVENTION

Where the description of the wind turbine 1 according to the invention mentions method features, these relate in particular to the method according to the invention. Likewise, physical features mentioned in the description of the method according to the invention relate to the wind turbine 1 according to the invention.

The first aspect of the invention relates to a wind turbine 1, comprising an inner corpus 3, which has a cylindrical main body 301 with a cowling 307 attached upstream and has a generator 303 arranged in the cylindrical main body 301. The wind turbine 1 furthermore comprises an outer corpus 5 which has a housing casing 501 and at least one funnel component 503 arranged in the housing casing 501, the cross section of which funnel component decreases in a flow direction, and a spherical cap component 505 arranged downstream in the housing casing 501.

Furthermore, the wind turbine 1 comprises at least one carrier rib 7 which connects the inner corpus 3 to the outer corpus 5, and a working turbine 9 which is arranged at the downstream end of the inner corpus 3 and which is connected to the generator 303 and which has a rotor 901.

The wind turbine 1 is characterized in that the outer corpus 5 forms, with the inner corpus 3, at least one convergent portion 507 which extends over the length of the inner corpus 3, and wherein the outer corpus 5, adjoining the downstream end of the inner corpus 3, forms a divergent portion 509.

In the present invention, “convergent portion” is to be understood to mean a flow channel which is convergent as viewed in the flow direction, that is to say a horizontal flow channel with a uniformly decreasing flow cross section. The convergent portion 507 serves for optimizing the air stream in the wind turbine 1.

In the present invention, “divergent portion” is to be understood to mean a flow channel which is divergent as viewed in the flow direction, that is to say a horizontal flow channel with a rapidly increasing cross-sectional area. The divergent portion 509 serves for enlarging the cross section of the flow channel.

“Spherical cap component” refers to a part of the outer corpus 5 which is situated at the downstream end of the wind turbine 1 and which at least partially has a partially spherical shape. The spherical cap component 505 has a rapidly increasing cross-sectional area and thus forms the housing for the divergent portion 509.

“Working turbine” is to be understood to mean a rotating turbomachine which converts the energy inherent in a flowing fluid, in this case in particular air, into mechanical energy, and outputs this via its shaft. In the present invention “rotor” refers to the rotating turning element of the working turbine 9. In one embodiment of the invention, the hub of the rotor 901 is of consolidated design such that it not only bears the rotor blades 9011 but simultaneously acts as a flywheel. The consolidation may consist in a greater diameter or a widening of the hub or in the use of a material with a relatively high density.

The outer corpus 5 is arranged around the inner corpus 3 and forms, in particular, the outer casing of the wind turbine 1. The inner corpus 3 is preferably of torpedo-like shape and has, upstream on its cylindrical main body 301, a preferably streamlined, conical cowling 307. To the generator 303, preferably an electrical generator, arranged in the cylindrical main body 301, there is preferably connected a gearbox 305, in particular a planetary gearbox.

As described above, at least one carrier rib 7 connects the inner corpus 3 to the outer corpus 5. Specifically, the at least one carrier rib 7 may be arranged on, that is to say fastened to, the cylindrical main body 301 and support the funnel component 503 arranged in the housing casing 501.

The outer corpus 5 has an inlet opening 101 upstream, that is to say at the inlet to the convergent portion 507, and has an outlet opening 103 downstream, that is to say at the outlet of the divergent portion 509.

The wind turbine 1 according to the invention has a length of 5 meters to 10 meters, in particular of 7 meters to 8 meters, and a diameter of 2 meters to 5 meters, in particular of 3 meters to 4 meters. The weight of the wind turbine 1 according to the invention is, depending on the dimensions, between 15 tons and 25 tons, and in particular approximately 20 tons. By comparison, conventional wind power installations have a weight of 120 tons to 150 tons.

With the present invention, it is possible to provide the wind turbine 1 according to the invention which offers high sensitivity to wind speeds, but which is robust and weather-resistant.

The efficiency of the individual wind turbine 1 is almost 3 times higher than that of conventional wind power installations. Furthermore, it is possible for multiple wind turbines 1 according to the invention to be installed on one conventional mast 13, for example, up to 15 turbines. Furthermore, the operation of the wind turbine 1 according to the invention is already possible at a height of 30 meters, whereas conventional wind power installations require heights of 70 meters to 150 meters. It is therefore possible for individual wind turbines 1 according to the invention to be conditioned for use, for example, in industrial plants.

Maintenance can be performed on a single wind turbine 1 according to the invention without the need for an entire installation of multiple wind turbines 1 to be completely deactivated. Furthermore, the outlay for transport and installation is considerably lower and more environmentally friendly, because the wind turbines 1 are relatively compact and small and also relatively lightweight in relation to conventional wind power installations. A conventional wind power installation with a power of 7 MW for example from the company Vestas requires investment of approximately 2.5 million Euros. The costs of manufacturing a wind turbine 1 according to the invention are at least comparable to the costs of conventional wind power installations but are generally considerably lower. However, the existing infrastructure, e.g. masts, feed-in, etc. can be adopted for the wind turbine 1 according to the invention, which reduces the overall costs of an installation.

In one refinement of the invention, the at least one carrier rib 2 is of spiral-shaped form in a flow direction. In this way, the air stream entering the wind turbine 1 according to the invention at the inlet opening is transformed from the linear movement into a spiral-shaped movement. The air stream is preferably diverted through 50° to 70°, preferably 55° to 65°, in particular through 60°, from the linear movement of the original air stream in order to optimally utilize the energy of the inflowing air stream.

The carrier rib 7 preferably has a cross section which corresponds to the cross section of an aircraft wing, and thus has a streamlined aerodynamic shape, which leads to an improvement in dynamics.

The wind turbine 1 according to the invention advantageously has two or more carrier ribs 7a, 7b, which connect the inner corpus 3 to the outer corpus 5, that is to say connect the cylindrical main body 301 to the funnel component 503, and two or more partial convergent portions 507a, 507b, . . . , that is to say, two or more flow channels which are of spiral-shaped form in the flow direction and which, at their downstream end, are directed toward the rotor 901 of the working turbine 9. The partial convergent portions 507a, 507b, . . . , which are in particular arranged at uniform parallel intervals, collectively form the convergent portion 507. The two or more carrier ribs 7a, 7b are preferably arranged uniformly along the circumferential length of the inner corpus 3, and have a uniform spiral-shaped condition path along the entire length.

In one preferred embodiment, the wind turbine 1 according to the invention has four carrier ribs 7a, 7b, 7c, 7d which divide the convergent portion 507 into four partial convergent portions 507a, 507b, 507c, 507d.

In order to direct the air stream from the convergent portions 507, 507a, 507b, . . . towards the rotor blades 9011 of the rotor 901 in a particularly targeted manner and thus optimally utilize the available energy, the working turbine 9 has a front stator 903 upstream of the rotor 901 in the flow direction. The front stator 903 has guide elements 9031 which may likewise be shaped in the manner of aircraft wings. The guide elements 9031 serve for conducting the air stream in targeted fashion onto the rotor 901, that is to say the rotor blades 9011.

The guide elements 9031 are preferably at an angle of 50° to 70°, preferably of 55° to 65°, in particular of 60°, with respect to the longitudinal axis of the wind turbine 1, and may have a cross section similar to an aircraft wing. The rotor blades 9011 are arranged on the rotor 901 such that they are at an angle of 80° to 100°, preferably of 85° to 95°, in particular of 90°, with respect to the guide elements 9031. In this way, the energy of the inflowing air stream is optimally utilized.

Alternatively or in addition, the working turbine 9 may have, downstream of the rotor 901 in the flow direction, a rear stator 905 which, owing to a grating effect, causes vortex formation in the air stream emerging from the rotor 901. As a result of the vortex formation at the lamellae 9051 of the rear stator 905, the compression losses are less, and the resulting energy is increased. The lamellae 9051 are preferably at an angle of 80° to 100°, preferably of 85° to 95°, in particular of 90°, with respect to the rotor blades 9011.

Preferably, the shaft of the rotor 901 is mounted in the hub of the rear stator 905. The rear stator 905 may, like the front stator 903, be connected to the outer corpus 5 and thus form a part of the supporting structure of the wind turbine.

In a preferred embodiment, the outer corpus 5 has two funnel components 5503a, 503b arranged concentrically with respect to one another and, together with the inner corpus 3, forms two convergent portions 5071, 5073. This embodiment offers the advantage of a mechanically more stable construction, such that the dimensions of the wind turbine 1 according to the invention can be enlarged without stability problems.

In one refinement of this preferred embodiment, the wind turbine 1 according to the invention has two times four carrier ribs 71a, 71b, 71c, 71d, 73a, 73b, 73c, 73d, which divide the convergent portions 5071, 5073 into two times four partial convergent portions 5071a, 5071b, 5071c, 5071d, 5073a, 5073b, 5073c, 5073d.

The funnel components 5503a, 503b are in this case advantageously connected to one another and to the housing casing 501 by one or more carrier ribs 71a, 71b, 71c, . . . , 73a, 73b, 73c, . . . . Preferably, the carrier ribs 71a, 71b, 71c, . . . , 73a, 73b, 73c, . . . are of spiral-shaped form in the flow direction in order to transform the linear movement of the air stream into a spiral-shaped movement of the air stream.

In order to prevent overloading of and damage to the wind turbine 1 according to the invention in the event of an intense air stream, that is to say for example during a storm, and in the event of sudden changes in wind speed, for example in the event of gusts of wind, it is the case in one refinement that the outer corpus 5 has a discharge channel 511 which is connected to the downstream region of the at least one convergent portion 507 and which is fully or partially closable in relation to the at least one convergent portion 507 by means of a closure device 513. In this way, a part of the air stream can be conducted past the working turbine 9, in the manner of a bypass, such that only a part of the air stream impinges on the working turbine 9.

The closure device 513 is preferably mechanically mounted, for example counter to a spring element, and opens the discharge channel 511 in the presence of a predefined pressure or in the event of a sudden change in the wind speed. In the case of gusts of wind, the discharge channel 511 thus smooths out the generator operation in accordance with the principle of a protection valve that is to say opening and closing of a throttle valve. In the presence of very high nominal winds, these can bypass the convergent portion 507 and reduce the resistance to the gusts of wind.

In the upstream inlet, that is to say the inlet opening 101 of the at least one convergent portion 507, at least one compensation ring 11 may be arranged concentrically with the inner corpus 3 and with the outer corpus 5 in order to direct the incoming air stream. Since the cowling 307 of the inner corpus 3 is arranged in the center of the inlet opening of the wind turbine 1 according to the invention, and thus, despite the conical shape, constitutes an obstruction to the air stream, the at least one compensation ring 11 contributes to a vortex-free introduction of the air stream into the at least one convergent portion 507. For this purpose, the at least one compensation ring 11 may also have the cross section of an aircraft wing.

The at least one compensation ring 11 furthermore has the effect that it geometrically decreases the size of the inlet opening 101, such that no animals in particular birds or objects can enter and block the at least one convergent portion 507. The compensation rings 11 form, together with the start of the at least one carrier rib 7, a type of protective grating in the inlet opening 101.

The above statements and preferences with regard to the wind turbine 1 according to the invention apply correspondingly to the method according to the invention described below. Likewise, the following statements and preferences with regard to the method according to the invention apply correspondingly to the wind turbine 1 according to the invention.

The above-stated object is achieved, in a second aspect of the present invention, by means of a method for generating electrical energy from an air stream by means of the wind turbine 1 according to the invention, which method firstly comprises the step a) of receiving an air stream from the surroundings in the at least one convergent portion 507 of the wind turbine 1, before, in step b), the air stream is accelerated and compressed in the at least one convergent portion 507 by means of a progressive decrease of the cross-sectional area thereof.

In step c), the accelerated, compressed air stream is conducted in targeted fashion to the rotor 901, thereby driving the working turbine 9, whereupon, in step d), after it passes through the rotor 901, the accelerated, compressed air stream is introduced into the divergent portion 509, and the air stream is slowed and expanded. In this way, a negative pressure is generated on the downstream side of the rotor 901, which further contributes to the increase in energy.

The method according to the invention basically has the same advantages as the wind turbine 1 according to the invention. In particular, the method according to the invention exhibits, for the individual wind turbines 1, increased efficiency in relation to conventional wind power installations, because there is substantially no limitation with regard to the utilizable wind speed.

In one refinement of the method,
in step b), the rectilinear flow movement of the air stream is converted by the at least one carrier rib 7 into a spiral-shaped flow movement, such that,
in step c), the accelerated, compressed air stream is conducted onto the rotor 901 at an obtuse angle, and,
in step d), a turbulent flow is generated in the divergent portion 509.

The spiral-shaped flow movement is diverted relative to the rectilinear flow movement through 50° to 70°, preferably 55° to 65°, in particular through 60°, in order to optimally utilize the energy of the inflowing air stream. The obtuse angle between the spiral-shaped flow movement and the rotor 901, or the rotor blades 9011, amounts to 80° to 100°, preferably 85° to 95°, particularly preferably 90°.

It may advantageously be provided that, in the event of a critical flow speed of the air stream from the surroundings being exceeded, or in the event of sudden changes in the flow speed, in step a), the closure device 513 is at least partially opened, and at least a part of the air stream is conducted past the rotor 901 through the discharge channel 511. Damage to the wind turbine 1 can thus be prevented.

The present invention relates, in a third aspect, to the use of the above-described wind turbine 1 for generating electrical energy from an air stream, wherein, in particular, use is made of the method described above.

Further aims, features, advantages and possible uses will emerge from the following description of exemplary embodiments, which do not restrict the invention, on the basis of the figures. Here, all of the features described and/or illustrated in the figures, individually or in any desired combination, form the subject matter of the invention, even independently of the combination thereof in the claims or the back-references thereof. In the figures:

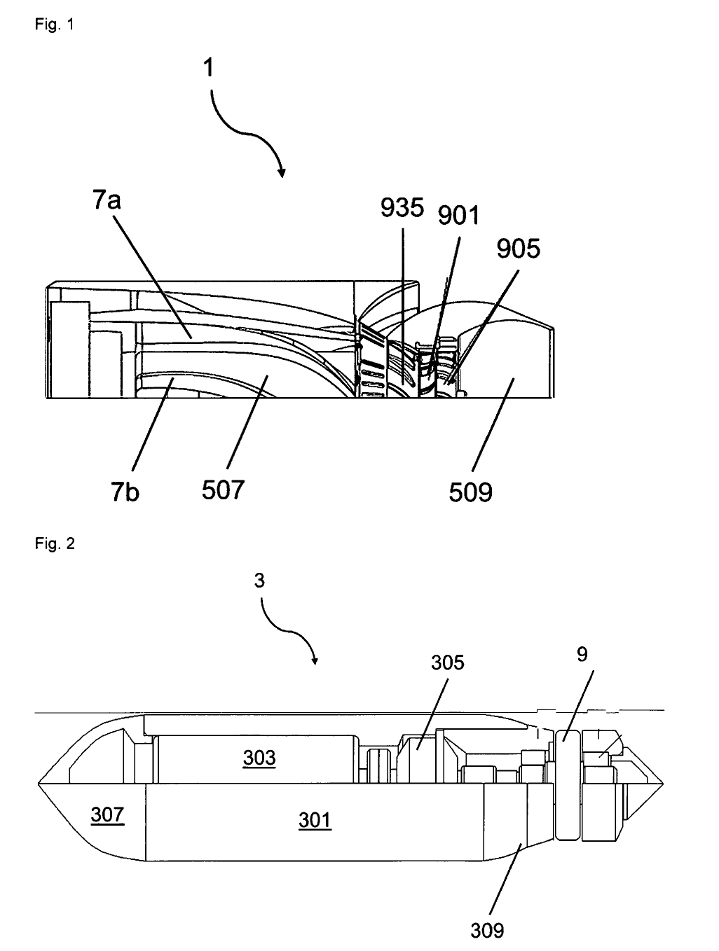

FIG. 1 is a schematic, partially sectional illustration of a wind turbine 1 according to the invention as per an embodiment of the invention.

FIG. 2 is a schematic, partially sectional illustration of an inner corpus 3 as per an embodiment of the invention.

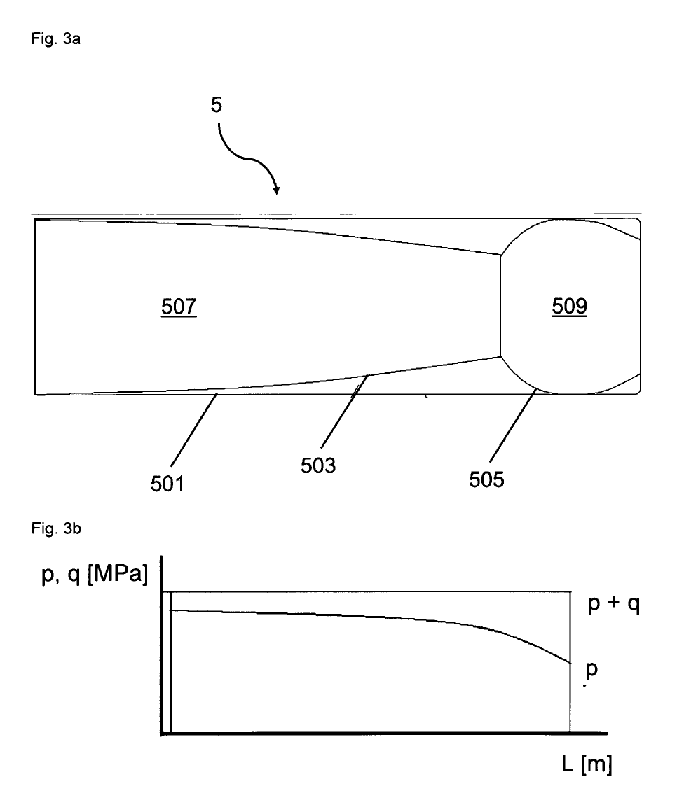

FIG. 3a is a schematic sectional illustration of an outer corpus 5 as per an embodiment of the invention with convergent portion 507 and divergent portion 509.

FIG. 3b shows a diagram for illustrating dynamic pressure and static pressure.

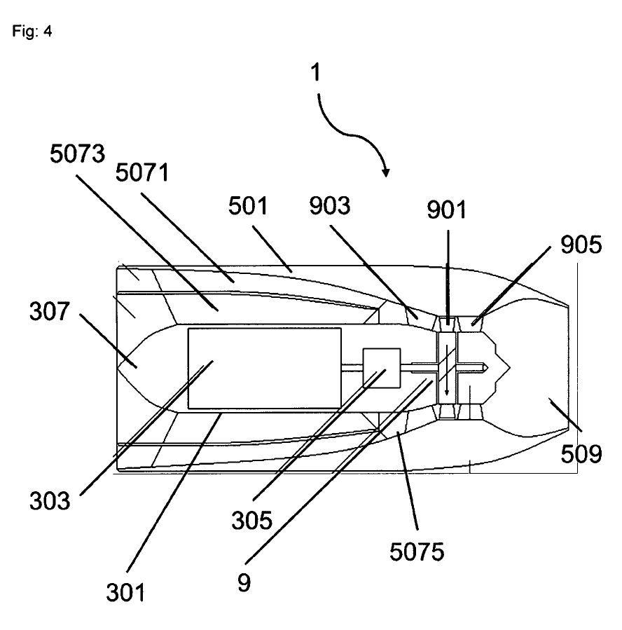

FIG. 4 is a schematic sectional illustration of a wind turbine 1 according to the invention as per an embodiment of the invention.

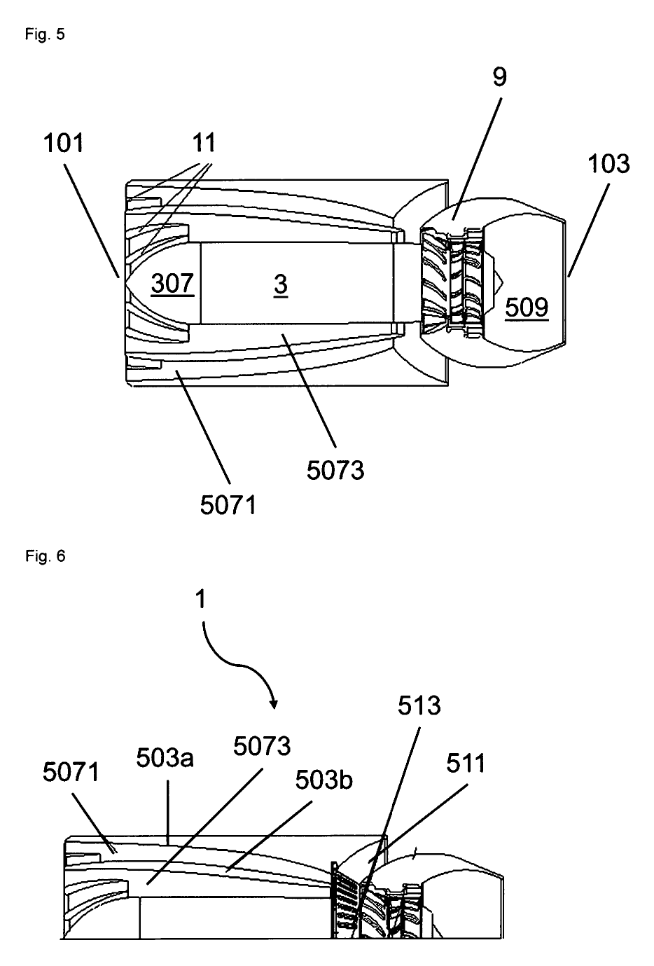

FIG. 5 is a schematic illustration of a wind turbine 1 according to the invention as per an embodiment of the invention.

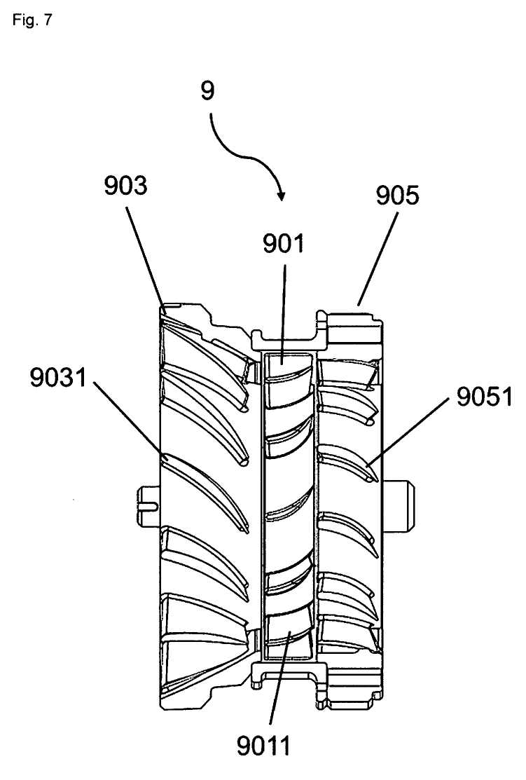

FIG. 6 is a schematic, partially sectional detail illustration of a wind turbine 1 according to the invention as per an embodiment of the invention.

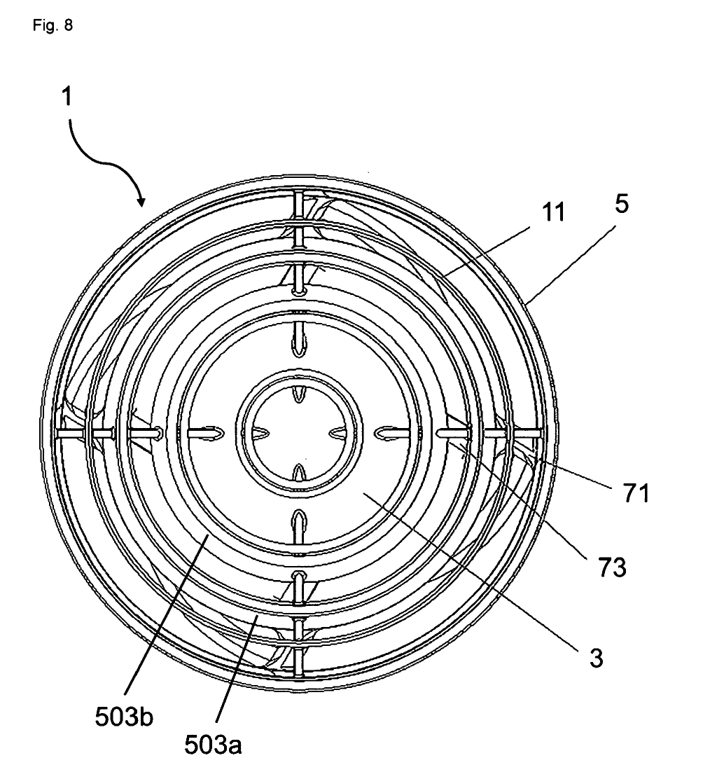

FIG. 7 is a schematic illustration of a working turbine 9 as per an embodiment of the invention.

FIG. 8 shows a front view of a wind turbine 1 according to the invention as per an embodiment of the invention.

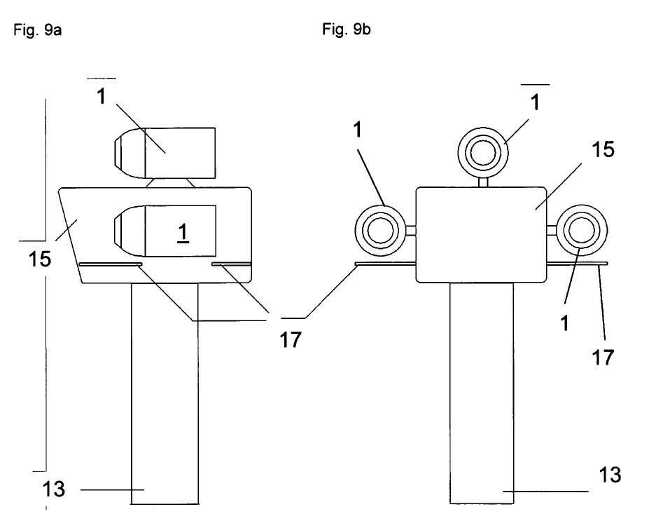

FIGS. 9a and 9b are schematic illustrations of multiple wind turbines 1 according to the invention on one mast 13.

FIG. 1 illustrates a wind turbine 1 according to the invention as per an embodiment of the invention, with a cut-away outer corpus 5, such that the convergent portion 507 and the divergent portion 509, with front stator 903, rotor 901, and rear stator 905 arranged in between, are at least partially visible. Also illustrated is the arrangement of a carrier rib 7.

FIG. 2 schematically illustrates the inner corpus 3 as per an embodiment of the invention, wherein the housing casing 301 is illustrated in partially cut-away form. In the housing casing 301 there is arranged a generator 303 with a gearbox 305 connected thereto, wherein the shaft of the working turbine 9 is connected to the gearbox 305 and thus to the generator 303. It is possible to clearly see the torpedo shape of the inner corpus 3 with the cowling 307 on the left-hand side and with a diameter reduction 309 on the right-hand side of the illustration of FIG. 2, such that the rotor 901 not illustrated here lies freely in the flow channel, likewise not illustrated here.

FIG. 3a is a schematic sectional illustration of an outer corpus 5 with funnel component 503 and spherical cap component 505 as per an embodiment of the invention and shows the convergent portion 507 and the divergent portion 509 with their basic shapes.

FIG. 3b is a diagram that illustrates dynamic pressure and static pressure, as prevail in principle in the convergent portion 507 and divergent portion 509 shown in FIG. 3a. FIG. 3b will be discussed again further below.

FIG. 4 is a schematic sectional illustration of a wind turbine 1 according to the invention as per an embodiment of the invention, in which two concentric convergent portions 5071, 5073 are illustrated, which are merged again in a concentrating zone 5075 upstream of the front stator 903. FIG. 4 furthermore shows the arrangement of the working turbine 9 with front stator 903, rotor 901, and rear stator 905 between the convergent portions 5071, 5073 or the concentrating zone 5075 and the divergent portion 509.

FIG. 5 is a schematic illustration of a wind turbine 1 according to the invention as per an embodiment of the invention, which is similar to FIG. 1, but, as in FIG. 4, has two concentric convergent portions 5071, 5073. The inlet opening 101 and the outlet opening 103 are also indicated. The embodiment illustrated in FIG. 5 has three compensation rings 11 in the inlet opening 101, which compensation rings conduct the air stream from the outside around the cowling 307 into the two convergent portions 5071, 5073.

FIG. 6 schematically illustrates, in detail, a wind turbine 1 according to the invention as per a further embodiment of the invention. This embodiment has two funnel components 503a, 503b which form the two convergent portions 5071, 5073. Also illustrated here is the discharge channel 511 with the closure device 513.

FIG. 7 is a schematic illustration of an embodiment according to the invention of the working turbine 9. This figure shows, partially in section, the front stator 903 with the guide elements 9031, the rotor 901 with the rotor blades 9011, and the rear stator 905 with the lamellae 9051. The guide elements 9031 are in this case at an angle of approximately 60° with respect to the longitudinal axis of the wind turbine 1 and at an angle of approximately 90° with respect to the rotor blades 9011. The lamellae 9051 are at an angle of approximately 30° to approximately 70° with respect to the longitudinal axis of the wind turbine 1. Rotor blades 9011, guide elements 9031, and lamellae 9051 each have a cross section similar to an aircraft wing.

FIG. 8 shows a front view of a wind turbine 1 according to the invention as per an embodiment of the invention. The inner corpus 3 and the outer corpus 5 are connected concentrically by means of the carrier ribs 71, 73. The funnel components 503a, 503b and the compensation rings 11 are arranged concentrically with respect to the inner corpus 3 and the outer corpus 5. It can be clearly seen how, in this way, a type of protective grating is formed in the inlet opening 101.

FIGS. 9a and 9b schematically show multiple wind turbines 1 according to the invention on one mast 13. The mast 13 has a nacelle 15, similar to conventional wind power installations, to which the wind turbines 1 according to the invention are attached. For the lateral wind turbines 1, there are furthermore provided working platforms 17, which are technically difficult to implement in the case of conventional wind power installations but which, according to the present invention, permit simple and safe servicing and maintenance of the wind turbine 1.

In accordance with the Bernoulli principle, the pressure of a flowing fluid, for example, of a gas, increases when its speed decreases, that is to say, conversely, the speed increases if the pressure decreases. This principle is applied, for example, in the case of the geometry of aircraft wings, such that a relatively high speed and therefore a relatively low pressure prevail at the top side thereof, with the result that lift is generated.

Consequently, if an air stream enters the convergent portion 507, said air stream is concentrated, and is accelerated owing to the decreasing cross-sectional area of the convergent portion 507.

The reason for this is that the air mass entering the convergent portion 507 through the inlet opening 101 of the wind turbine 1 in a unit of time is equal to the air mass exiting at the end of the convergent portion 507 in the same unit of time. To achieve the significant acceleration of the air stream in the case of a relatively short length of the convergent portion 507 with minimum friction losses, air resistance and internal gas friction, a uniform and controlled acceleration is required. A known fact is that any abrupt change in speed or direction of an air stream leads to an energy loss. To reduce or prevent such losses, the convergent portion 507 must have a precise defined optimum shape and proportions which permit the acceleration of the stream with a linear dependency. The convergent portion 507 is in particular designed such that its cross-sectional area decreases with a predetermined dependency with the aerodynamic coefficient of 10°. This permits a uniform and orderly acceleration of the air stream.

The sum of the static and dynamic pressures remains constant. The dynamic pressure can be regarded as the inertia upon the collision of the moving air masses minus the wind pressure. Owing to the acceleration of the air stream in the convergent portion 507, the dynamic pressure increases, and the static pressure decreases cf. FIG. 3b, wherein the sum thereof remains constant. The drop in the static pressure in the convergent portion 507 determines the movement of the air stream, and the parabolic curve determines the acceleration thereof. The drop in the static pressure leads to a drop in the air density. The accelerated air is thus expanded.

As a result of the considerable acceleration of the air stream in the convergent portion 507, a “micro-tornado” with high-speed and very high dynamic pressure is generated. The combination of high speed and high dynamic pressure generates energy several times greater than that of a nominal air stream. Specifically, the utilizable kinetic energy of an air stream is proportional to the third power of the speed of said air stream. A doubling of the speed of the air stream consequently increases the utilizable kinetic energy by a factor of eight.

After the accelerated air stream has passed through the end of the convergent portion 507, a turbulent air vortex is generated in the divergent portion 509 in the form of a short expanding channel. This effect can likewise be compared to a “micro-tornado”. The turbulent air vortex is, as it were, a thinning of the air and leads to a drop in the static pressure in the divergent portion 509 downstream of the rear stator 905. This is a spiral-shaped air vortex with a high flow speed and a low linear inlet speed. The thinned air acts here in the manner of a stressed spring which seeks to contract. The turbulent drop in the static pressure in the divergent portion 509 generates a difference in the static pressure upstream and downstream of the end of the convergent portion 507, which generates additional outlet energy.

An accelerated but greatly thinned air stream is conducted through the divergent portion 509. Upon the collision with the ambient air, the atmospheric pressure and the nominal density and speed, said air stream contracts to the nominal density and slows its speed to the nominal wind speed within a few meters downstream of the outlet opening 103, wherein said air stream adopts the parameters of the atmospheric air. This mass contraction enables the air stream to pass through the outlet opening 103 into an environment of relatively high pressure without causing a braking effect.

The dynamic pressure increases as far as the end of the convergent portion 507 and thereafter rapidly decreases owing to the gradual drop in speed and owing to the gradual drop in air density in the divergent portion 509. A working turbine 9 with a rotor 901 is therefore arranged at the end of the convergent portion 507 in order to transform the air stream in spiral form into a mechanical torque.

To achieve even better results, the linear movement of the air stream is transformed in uniform and controlled fashion into a spiral-shaped rotational movement by means of elongate spiral-shaped carrier ribs 7 which are fastened in the convergent portion 507. In particular, it is advantageous for the linear movement of the air stream to be accelerated and transformed in uniform and controlled fashion into the spiral-shaped movement in order to prevent, or minimize, loss of inertia. Consequently, an improved aerodynamic coefficient is achieved. The accelerated air stream is preferably directed onto the rotor 901, or the rotor blades 9011, at right angles. This in turn increases the energy generated. A spiral-shaped turbulent air vortex with a high tangential but reduced axial speed is conducted through the divergent portion 509. The effect may also be compared to a “micro-tornado” which is generated in the divergent 509, not at the periphery thereof.

The transformation of the local air stream, which is composed of the acceleration of the air stream in the convergent portion 507 together with the transformation of the rectilinear movement thereof into a spiral-shaped movement and the generation of a powerful turbulent air vortex or of a drop in the static pressure downstream of the rotor 901, into a mechanical torque permits the concentration of high output power of the rotor 901 with a significantly more compact structure of the wind turbine 1, even in the case of a low nominal wind speed. Consequently, the generation of a high mechanical torque with a high frequency of the working turbine 9 generates a significant level of output power that is fed to the electrical generator 303. It is thus possible for the wind turbine 1 according to the invention to be operated even with a low nominal wind speed.

The aerodynamics of the convergent portion 507 are not trivial. They are based on the aerodynamics of parallel guide channels. By means of the convergent portion 507, or the convergent portions 5071, 5073, an incoming air stream is divided into identical parallel air streams, which in turn are directed and accelerated in a precise manner such that, upstream of the front stator 903, they are merged again in concentrated fashion in a concentrating zone 5075 and conducted to the rotor 901.

The wind turbine 1 is more compact, more lightweight and less expensive than conventional wind power installations. It exhibits high sensitivity to the wind speed, in the simultaneous absence of an upper critical speed. The capacity averaged over a year is 70% to 80% of the maximum power, compared with an average capacity of approximately 34% for conventional wind power installations. By contrast to the latter, the wind turbines 1 according to the invention do not influence one another if they are situated close together. It is thus possible for multiple wind turbines 1 to be positioned on one mast 13, that is to say more power can be generated with lower costs. The individual masts 13 can be positioned closer together in a wind farm. The present invention shows that wind turbines 1 according to the invention for generating large amount of electrical energy can be produced with considerably lower initial investment.

What is claimed is:

1. A wind turbine, comprising
an inner corpus, which has a cylindrical main body with a cowling attached upstream and has a generator arranged in the cylindrical main body,
an outer corpus which has a housing casing and at least one funnel component arranged in the housing casing, the cross section of which funnel component decreases in a flow direction, and a spherical cap component arranged downstream in the housing casing,
at least one carrier rib which connects the inner corpus to the outer corpus, and
a working turbine which is arranged at the downstream end of the inner corpus and which is connected to the generator and which has a rotor,
wherein the outer corpus forms, with the inner corpus, at least one convergent portion which extends over the length of the inner corpus, and wherein the outer corpus, adjoining the downstream end of the inner corpus, forms a divergent portion.

2. The wind turbine of claim 1, wherein the at least one carrier rib is of spiral-shaped form in a flow direction.

3. The wind turbine of claim 2, wherein two or more carrier ribs connect the inner corpus to the outer corpus and form two or more, preferably spiral-shaped partial convergent portions which, at their downstream end, are directed toward the rotor of the working turbine.

4. The wind turbine of claim 1, wherein the working turbine has a front stator upstream of the rotor in the flow direction and/or has a rear stator downstream of the rotor in the flow direction.

5. The wind turbine of claim 1, wherein the outer corpus has two funnel components arranged concentrically with respect to one another and, together with the inner corpus, forms two convergent portions.

6. The wind turbine of claim 1, wherein the outer corpus has a discharge channel which is connected to the downstream region of the at least one convergent portion and which is fully or partially closable in relation to the at least one convergent portion by means of a closure device.

7. The wind turbine of claim 1, wherein, in the upstream inlet of the at least one convergent portion, at least one compensation ring is arranged concentrically with the inner corpus and with the outer corpus.

8. A method for generating electrical energy from an air stream by means of the wind turbine according to claim 1, comprising the steps:
a) receiving an air stream from the surroundings in the at least one convergent portion of the wind turbine,
b) accelerating and compressing the air stream in the at least one convergent portion by means of a progressive decrease of the cross-sectional area thereof,
c) conducting the accelerated, compressed air stream in targeted fashion to the rotor, and thereby driving the working turbine,
d) after it passes through the rotor, introducing the accelerated, compressed air stream into the divergent portion and slowing and expanding the air stream.

9. The method of claim 8, wherein,
in step b), the rectilinear flow movement of the air stream is converted by the at least one carrier rib into a spiral-shaped flow movement, such that,
in step c), the accelerated, compressed air stream is conducted onto the rotor at an obtuse angle, and,
in step d), a turbulent flow is generated in the divergent portion.

10. The method of claim 8, wherein, in the event of a critical flow speed of the air stream from the surroundings being exceeded, in step a), the closure device is at least partially opened, and at least a part of the air stream is conducted past the rotor through the discharge channel.
